(19) United States
(12) Patent Application Publication
(10) Pub. No.: US 2025/0046912 A1
(43) Pub. Date: Feb. 6, 2025

(54) BATTERY CASE, AND THERMAL MANAGEMENT SYSTEM WITH BATTERY CASE

(71) Applicant: Dong Hee Industrial Co., Ltd, Ulsan (KR)

(72) Inventors: Seung Cheol HAN, Gyeonggi-do (KR); Byeong Jin SHIN, Gyeongsangbuk-do (KR); Do Yeop KIM, Gyeonggi-do (KR); Geon Eung LEE, Gyeonggi-do (KR); Sang Dae KIM, Gyeonggi-do (KR); Dong Dae PARK, Gyeonggi-do (KR)

(21) Appl. No.: 18/720,391

(22) PCT Filed: Dec. 26, 2022
(86) PCT No.: PCT/KR2022/020577

§ 371 Date: Jun. 14, 2024

(30) Foreign Application Priority Data
Dec. 16, 2021 (KR) 10-2021-0180843

(51) Int. Cl. H01M 10/6568; H01M 10/48; H01M 10/613; H01M 10/63; H01M 50/233; H01M 50/249; H01M 50/262; H01M 50/271

(52) U.S. Cl. CPC H01M 10/6568; H01M 10/486; H01M 10/613; H01M 10/63; H01M 50/233; H01M 50/249; H01M 50/262; H01M 50/271

(57) ABSTRACT

A battery case and a heat management system for a battery module having the battery case, in which the battery case ensures airtightness allowing a liquid immersion cooling method based on a nonconductive refrigerant to be used in managing the heat of the battery module, and the internal temperature of the battery case and the level of the nonconductive refrigerant are controlled to remain constant so as to keep the battery cell below an ignition point, thereby preventing a fire from breaking out.

### CROSS-REFERENCE TO RELATED APPLICATIONS

This application claims priority to and the benefit of Korean Patent Application No. 10-2021-0180843 filed in the Korean Intellectual Property Office on Dec. 16, 2021, the entire contents of which are incorporated herein by reference.

### FIELD

The disclosure relates to a battery case, which cools a battery to maintain the durability and performance of the battery and prevent a fire, and a heat management system for a battery module having the battery case.

### BACKGROUND

In general, a battery refers to a cell that uses chemical energy to produce electrical energy, and a secondary cell can be used repeatedly as it is chargeable and dischargeable, and employed as a power source for driving motors of an electric vehicle (EV), a hybrid electric vehicle (HEV), etc.

The battery includes a battery module including a plurality of battery cells, and a battery pack completed by assembling the battery modules. The battery pack generates a lot of heat due to charging or discharging operations. In other words, overcharging or electrical/physical shock causes the battery pack frequently to overheat, thereby having a problem of causing a fire in the battery pack.

To solve this problem, a plurality of cooling fins or cooling pipes or the like cooling module is generally installed inside the battery case to cool only the exposed surfaces of the battery cells by the cooling channels of the battery pack using heat dissipation resin as a medium. The related art has been disclosed in KR 10-2016-0051882 A.

However, the cooling module merely lowered the ambient temperature of the battery cells, and relied on only thermal conductivity, thereby causing another problem of low cooling efficiency. The low cooling efficiency of the battery means decrease in the overall energy efficiency of a vehicle. Accordingly, there was a need for significantly increasing the cooling efficiency of the battery through novel concept.

Further, it was not easy to extinguish a fire that broke out in the battery of the vehicle, and thus technology of effectively preventing the fire in the battery was also required.

The foregoing matters described as the related art are only for enhancing the understanding of the background of the disclosure and should not be taken as an acknowledgement that they are the prior art already known to a person having ordinary skill in the art.

### SUMMARY

### Disclosure

### Technical Problem

The disclosure is proposed to solve such problems, and an aspect of the disclosure is to provide a battery case and a heat management system for a battery module having the battery case, in which the battery case ensures airtightness allowing a liquid immersion cooling method based on a nonconductive refrigerant to be used in managing the heat of the battery module, and the internal temperature of the battery case and the level of the nonconductive refrigerant are controlled to remain constant so as to keep the battery cell below an ignition point, thereby preventing a fire from breaking out.

### Technical Solution

According to an embodiment of the disclosure, a battery case includes: a housing including an inner space and an opening, and allowing a battery module to be inserted and mounted into the inner space through the opening; a cover fastened to the opening of the housing to close the opening, sealing the inner space of the housing upon closing the opening, and removable as unfastened from the opening; and an inlet and an outlet formed in the housing or the cover, allowing a nonconductive refrigerant to flow into or out of the inner space of the housing so that the battery module in the inner space of the housing can exchange heat with the nonconductive refrigerant.

In the battery case, the inlet for the nonconductive refrigerant may be formed in the housing, and the outlet for the nonconductive refrigerant is formed in the cover.

The battery case may further include a fastener to fasten the cover to the opening of the housing.

In the battery case, the housing may include a locking protrusion for fastening of the fastener, and the fastener may be provided in the cover and include a locking portion formed on a first side thereof and hooked to the locking protrusion, and a handle formed on a second side thereof to fasten or unfasten the locking portion so that the housing and the cover are fastened as the locking portion is hooked to the locking protrusion.

In the battery case, the cover may include a locking protrusion for fastening of the fastener, and the fastener may be provided in the housing and include a locking portion formed on a first side thereof and hooked to the locking protrusion, and a handle formed on a second side thereof to fasten or unfasten the locking portion so that the housing and the cover are fastened as the locking portion is hooked to the locking protrusion.

In the battery case, the housing may include a plurality of mounting portions for fastening the battery case to a vehicle body, the fasteners may be formed between the mounting portions on a lateral side where the plurality of mounting portions are formed, and a single fastener may be formed extending along a lengthwise direction of a lateral side where the plurality of mounting portions are not formed.

The battery case may further include a seal or sealer provided between an end facing the cover at an edge of the opening of the housing and an end facing the opening of the housing at an edge of the cover, wherein the sealer is compressed as the cover is fastened to the opening of the housing.

The battery case may further include an electrode plate formed to penetrate the cover, and including a first side provided in the inner space of the housing and thermally connected to a battery heat generating portion, and a second side provided outside the cover and enabling the battery to be charged and discharged.

The battery case may further include a shock absorber provided on a lower surface of the inner space of the housing, supporting the battery modules mounted to the inner space of the housing in an upward direction, and absorbing external shocks applied from a lower side of the housing.

According to an embodiment of the disclosure, a heat management system for a battery module with the foregoing battery case may include: a plurality of battery cases; a hub channel connected to the inlet and the outlet formed for the nonconductive refrigerant in each battery case, and allowing the nonconductive refrigerant to flow therein; a plurality of valves provided in the hub channel and controlling a flow rate of the nonconductive refrigerant flowing into each battery case; and a controller configured to individually control each valve to adjust an inner temperature of each battery case and a level of the nonconductive refrigerant.

In the heat management system of the battery module, the hub channel may include an inflow channel through which the nonconductive refrigerant flows into the battery case, and a recovery channel through which the nonconductive refrigerant passed through the battery case is recovered, the plurality of battery cases with the battery modules inserted in the inner spaces thereof may be arranged adjacent to each other, and the inlets for the nonconductive refrigerant of the battery cases are disposed facing each other, and the inflow channels may be disposed between opposite inlets for the nonconductive refrigerant of the battery cases.

In the heat management system of the battery module, the plurality of valves may be provided in the inflow channel, and each valve may be connected to the opposite inlets for the nonconductive refrigerant to control the flow rate of the nonconductive refrigerant flowing into opposite battery cases.

In the heat management system of the battery module, each battery case may further include a sensor configured to detect a level of the nonconductive refrigerant and a temperature of a battery heat generating portion, and the controller may be configured to individually control the plurality of valves based on detection results of the sensors.

In the heat management system of the battery module, the controller may be configured to open the valve to concentrate the flow rate of the nonconductive refrigerant on a corresponding battery case when the sensor's detection result is higher than or equal to a reference temperature.

In the heat management system of the battery module, the controller may be configured to open the valve to concentrate the flow rate of the nonconductive refrigerant on a corresponding battery case when the sensor's detection result does not reach a reference level.

### Advantageous Effects

In a battery case according to the disclosure and a heat management system for a battery module having the battery case, the battery case ensures airtightness allowing a liquid immersion cooling method based on a nonconductive refrigerant to be used in managing the heat of the battery module, and the internal temperature of the battery case and the level of the nonconductive refrigerant are controlled to remain constant so as to keep the battery cell below an ignition point, thereby preventing a fire from breaking out.

### BRIEF DESCRIPTION OF THE DRAWINGS

FIG. 1 is a view illustrating a battery case according to an embodiment of the disclosure.

FIG. 2 is an exploded perspective view of a battery case according to an embodiment of the disclosure.

FIG. 3 is a lateral view of a battery case according to an embodiment of the disclosure.

FIG. 4 is a view illustrating operations of a fastener in a battery case according to an embodiment of the disclosure.

FIG. 5 is a view illustrating a fastened state of a fastener in a battery case according to an embodiment of the disclosure.

FIG. 6 is a view illustrating a heat management system for a battery module according to an embodiment of the disclosure.

### DETAILED DESCRIPTION

Throughout this specification, when a certain portion “includes” a certain element, this means that other elements may further be included rather than excluded unless explicitly described to the contrary.

Below, the configurations and operation principles according to various embodiments of the disclosure will be described in detail with reference to the accompanying drawings.

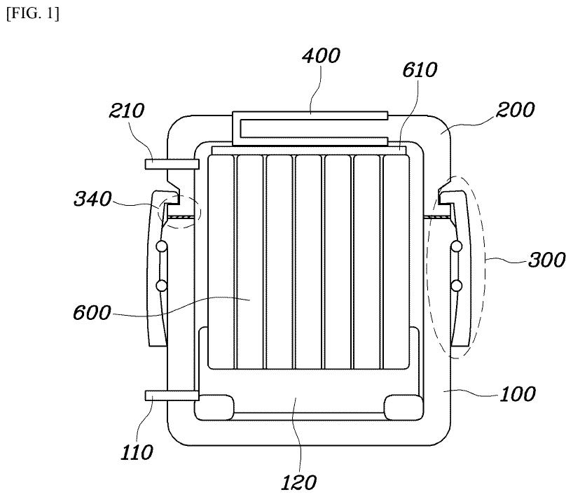

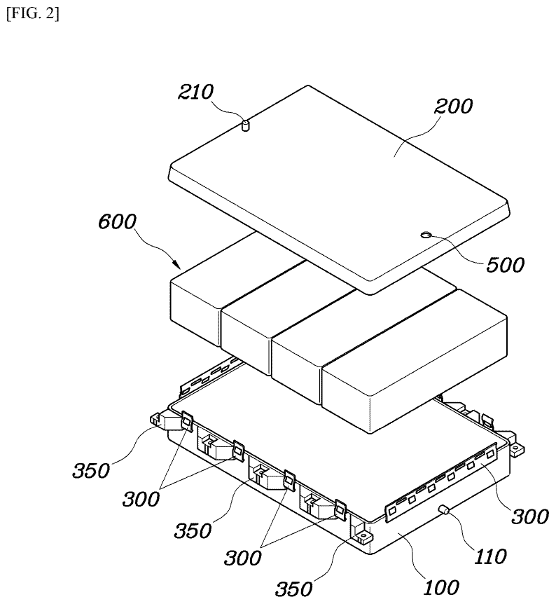

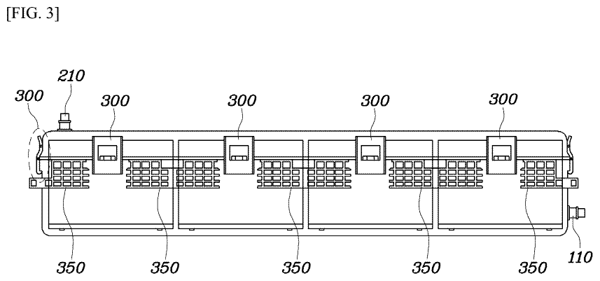

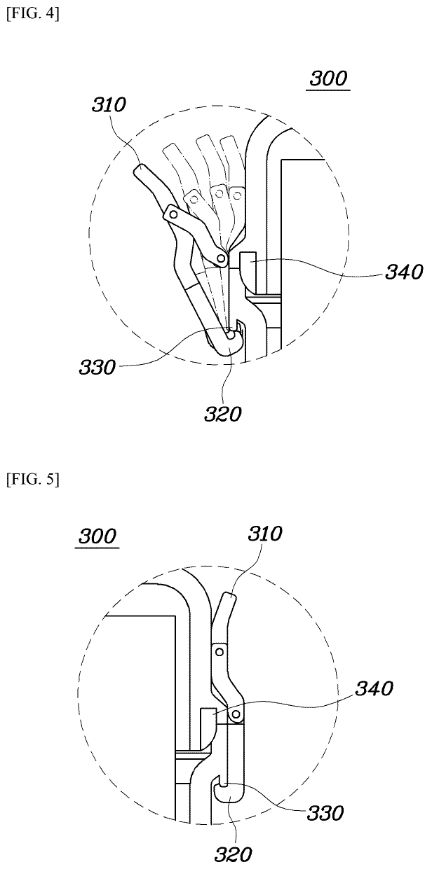

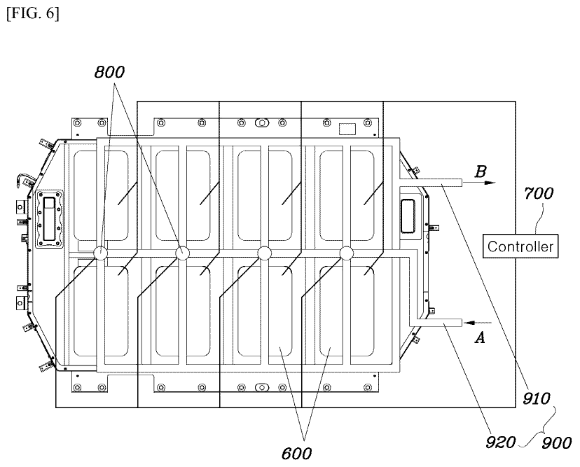

FIG. 1 is a view illustrating a battery case according to an embodiment of the disclosure, FIG. 2 is an exploded perspective view of a battery case according to an embodiment of the disclosure, FIG. 3 is a lateral view of a battery case according to an embodiment of the disclosure, FIG. 4 is a view illustrating operations of a fastener 300 in a battery case according to an embodiment of the disclosure, FIG. 5 is a view illustrating a fastened state of the fastener 300 in a battery case according to an embodiment of the disclosure, and FIG. 6 is a view illustrating a heat management system for a battery module according to an embodiment of the disclosure.

To help the understanding of the disclosure, chronic problems in the field of a battery will be first presented, and the key features of the disclosure to solve such problems will be described in sequence.

A battery includes a battery module 600 including a plurality of battery cells, and a battery pack completed by assembling the battery modules 600. The battery pack includes a battery case in which the battery modules 600 are inserted, and a controller (e.g., a battery management system (BMS)) 700 for controlling a plurality of battery modules 600, thereby making up a battery module system.

In other words, the battery modules 600, the battery case, and the controller 700 are generally needed to constitute the battery module system. Therefore, this specification will describe the battery case separately manufactured to have a special shape, and the battery module system including this battery case.

In particular, the battery module system will be described for a battery module heat management system that efficiently improves heat dissipation performance and prevents a fire from breaking out due to battery overheating, in relation to a heat generation problem of the battery, i.e., a chronic problem in the battery field, with recent regulations on exhaust gas and growing trends in electric vehicle markets.

FIG. 1 is a view illustrating a battery case according to an embodiment of the disclosure, and FIG. 2 is an exploded perspective view of a battery case according to an embodiment of the disclosure.

Referring to FIGS. 1 and 2, the battery case according to the disclosure includes a housing 100 formed with an inner space and an opening so that the battery modules 600 can be inserted in and mounted to the inner space through the opening; a cover 200 fastened to the opening of the housing 100 to close the opening, sealing the inner space of the housing 100 when closing the opening, and removable from the opening as unfastened; and an inlet 110 and an outlet 210 formed in the housing 100 or the cover 200, and allowing a nonconductive refrigerant to flow in and out of the inner space of the housing 100 so that the battery module 600 in the inner space of the housing 100 can exchange heat with the nonconductive refrigerant.

As described above, it will be premised that the battery case according to the disclosure is applied to the heat management system of the battery module 600, and the battery module heat management system according to the disclosure is based on a liquid immersion cooling method. Therefore, a refrigerant used herein is required to be the nonconductive refrigerant, which has a lower surface tension than a general refrigerant, and it is thus necessary for improving the airtightness or sealing performance of the battery case.

Accordingly, the battery case according to the disclosure basically includes the housing 100 into which the battery modules 600 are inserted and mounted, the cover 200 detachably covering the housing 100, and the inlet 110 and the outlet 210 formed in the housing 100 or the cover 200 so that the battery module 600 can exchange heat with the nonconductive refrigerant.

Specifically, the housing 100 is formed with the inner space and the opening. The battery modules 600 are inserted in the inner space through the opening, and mounted to the inner space. By fastening the cover to the opening, the opening is closed and the inner space of the housing 100 is sealed.

In this case, the cover 200 is formed to be unfastened and removable from the opening. Therefore, when the battery module system is assembled or repaired, the battery module 600 to be mounted to the inside of the battery case according to the disclosure is easily inserted or replaced.

Meanwhile, the battery case according to the disclosure is to be applied to the heat management system of the battery modules 600, and therefore the battery modules 600 mounted to the inner space of the housing 100 need to be formed to exchange heat with the nonconductive refrigerant in the state that the inner space of the housing 100 is sealed as the cover 200 is fastened to the opening of the housing 100.

In other words, the battery case according to the disclosure includes the inlet 110 and the outlet 210 provided in the housing 100 or the cover 200, so that the nonconductive refrigerant can flow into the inner space of the housing 100 through the inlet 110 and flow out of the inner space of the housing 100 through the outlet 210.

Meanwhile, in the battery case according to the disclosure, the inlet 110 for the nonconductive refrigerant may be formed in the housing 100, and the outlet 210 for the nonconductive refrigerant may be formed in the cover 200.

In the battery case according to the disclosure, the inlet 110 and the outlet 210 may be formed in either the housing 100 or the cover 200. However, as shown in FIG. 1, it is preferable that the inlet 110 is formed in the housing 100 and the outlet 210 is formed in the cover 200.

When the direction of gravity is taken into account, the battery module 600 is inserted into and mounted to the inner space of the housing 100, and the opening opened upwards in the housing 100 is covered with the cover 200. Therefore, the battery module is generally mounted to an electric vehicle or the like with the cover 200 located on an upper side and the housing 100 located on a lower side.

To dissipate heat generated while the battery is operating, it is required to evenly distribute the refrigerant that is in contact with and exchanges heat with a heat generating portion (e.g., a lead portion) of the battery. Therefore, the inlet 110 is provided in the housing 100 so as to fill the battery case with the refrigerant gradually from the bottom of the inner space, and the outlet 210 is provided in the cover 200 so as to discharge the refrigerant through the outlet 210 formed above the inner space of the battery case in the state that the level of the refrigerant is high enough to immerse a battery heat generating portion 610 in the refrigerant.

On the contrary, the inlet 110 may be formed in the cover 200, and the outlet 210 may be formed in the housing 100. In this case, the inlet 110 is located on the upper side and the outlet 210 is located on the lower side. Therefore, the battery module 600 may be shocked when the refrigerant suddenly flows in, and it is difficult to make the level of the refrigerant remain constant because the refrigerant flows out through the outlet 210 formed on the lower side as soon as the refrigerant flows in.

Of course, when the battery case is structured to be mounted lying on its side, it does not matter where the inlet 110 and the outlet 210 are formed.

However, as will be described later, the battery case according to the disclosure may further include an electrode plate 400 that enables the battery to be charged/discharged. The electrode plate 400 may be placed on the cover 200 rather than the housing 100 to which the battery module 600 is mounted and fixed. Further, the battery module heat management system may include a valve 800 that is installed adjacent to the inlet 110 and controls a flow rate of the refrigerant flowing in through the inlet 110. Because the valve 800 is controlled by an electrical signal, it is preferable that the position of the valve 800 and the position of the electrode plate 400 for electrical charging and discharging are as far away from each other as possible.

That is, in this regard, it is preferable that the inlet 110 is formed in the housing 100 and the outlet 210 is formed in the cover 200 because the electrode plate 400 needs to be installed as far as possible away from the valve 800 installed in the inlet 110, and the electrode plate 400 is installed in the cover 200.

FIG. 4 is a view illustrating operations of a fastener 300 in a battery case according to an embodiment of the disclosure, and FIG. 5 is a view illustrating a fastened state of the fastener 300 in a battery case according to an embodiment of the disclosure.

Referring to FIGS. 4 and 5, the battery case according to the disclosure may further include the fastener 300 that fastens the cover 200 to the opening of the housing 100.

FIGS. 4 and 5 illustrate a snap latch type fastener 300, but various fastening members may be used. In other words, these are merely examples to help the understanding of the disclosure, and do not limit the disclosure to the illustrated examples.

Below, the description in this specification will be made based on the snap latch type fastener 300 shown in FIGS. 4 and 5 to help the understanding of the disclosure. The snap latch type fastener 300 refers to the fastener 300 that has a fastening force formed based on interaction between a latch and a groove with which the latch engages, and is suitable for fastening the cover 200 of the battery case according to the disclosure to the opening of the hosing 100 because its fastening and installation are simple and easy compared to other fastening members and it secures a strong fastening force.

In addition, the airtightness of the battery case is further improved by using the separate fastener 300 rather than simply providing an insertion projection and an insertion groove in the cover 200 or the housing 100 and inserting the insertion projection in the insertion groove.

Meanwhile, the fastener 300 according to the disclosure may include a locking protrusion 330 for the fastening of the fastener 300, a locking portion 320 formed on a first side of the fastener 300 and hooked to the locking protrusion 330, and a handle 310 formed on a second side of the fastener 300 and fastening or unfastening the locking portion 320.

Specifically, the locking protrusion 330 for the fastening of the fastener 300 is formed in the housing 100 of the battery case according to the disclosure, and the fastener 300 is formed in the cover 200 and includes the locking portion 320 formed on the first side and hooked to the locking protrusion 330 and the handle 310 formed on the second side and fastening or unfastening the locking portion 320, thereby fastening the housing 100 and the cover 200 as the locking portion 320 is hooked to the locking protrusion 330.

In other words, the locking protrusion 330 is formed in the housing 100, and the locking portion 320 and the handle 310 are formed in the cover 200. By operating the handle 310, a fastening force is exerted as the locking portion 320 is hooked to the locking protrusion 330, and thus the cover 200 is fastened to the opening of the housing 100 by this fastening force.

Referring to the snap latch type fastener 300 shown in FIGS. 4 and 5, the handle 310 is rotatably coupled to a lateral side of an end facing the opening of the housing 100 at the edge of the cover 200. Here, the meaning of the rotatable coupling may be understood as, for example, hinge coupling or the like structure. However, this is merely an example to help the understanding of the disclosure, and the disclosure is not limited by this description.

Referring to FIG. 4, the handle 310 may be rotated around a point of connection with the cover 200 in a direction close to or away from the cover 200. In other words, the fastener 300 is fastened by rotating the handle 310 in the direction close to the cover 200 in the state that the locking portion 320 is hooked to the locking protrusion 330, and the fastener 300 is unfastened by rotating the handle 310 in the direction away from the cover 200.

Further, FIG. 5 illustrates that the fastening is completed as the handle 310 is rotated in the direction close to the cover 200 and comes into close contact with the cover 200. In this state, the locking portion 320 hooked to the locking protrusion 330 exerts the fastening force in a direction of restricting the separation of the cover 200 from the housing 100, thereby maintaining the cover 200 and the housing 100 coupled rather than separated. Therefore, it is ensured that the airtightness of the battery case is excellent.

Meanwhile, contrary to the above, the locking protrusion 330 for the fastening of the fastener 300 is formed in the cover 200 of the battery case according to the disclosure, and the fastener 300 is formed in the housing 100 and includes the locking portion 320 formed on the first side and hooked to the locking protrusion 330 and the handle 310 formed on the second side and fastening or unfastening the locking portion 320, thereby fastening the housing 100 and the cover 200 as the locking portion 320 is hooked to the locking protrusion 330.

In other words, the locking protrusion 330 in this case is formed in the cover 200, and the locking portion 320 and the handle 310 are formed in the housing 100. Such a structure of the fastener 300 is shown in FIG. 1.

In this case, the fastener 300 is formed to have the same structure as above, but different only in locations where the elements 310, 320 and 330 are formed. In other words, the handle 310 is coupled rotatably to a lateral side of an end facing the opening of the housing 100 at the edge of the opening. Further, the handle 310 may be rotated around a point of connection with the housing 100 in a direction close to or away from the housing 100.

In other words, the fastener 300 is fastened by rotating the handle 310 in the direction close to the housing 100 in the state that the locking portion 320 is hooked to the locking protrusion 330, and the fastener 300 is unfastened by rotating the handle 310 in the direction away from the housing 100.

As a result, the locations where the elements 310, 320, and 330 of the fastener 300 are formed may be optionally changed and applied as necessary in a process of producing/manufacturing the battery case according to the disclosure, thereby having an effect on increasing convenience in product design.

FIG. 2 is an exploded perspective view of a battery case according to an embodiment of the disclosure, and FIG. 3 is a lateral view of a battery case according to an embodiment of the disclosure.

Referring to FIGS. 2 and 3, the housing 100 of the battery case according to the disclosure includes a plurality of mounting portions 350 for fastening the battery case to a vehicle body, and the fasteners 300 are formed between the mounting portions 350 on a lateral side where the plurality of mounting portions 350 are formed. On a lateral side where the plurality of mounting portions 350 are not formed, a single fastener 300 may be formed along the lengthwise direction of the lateral side.

The battery case into which the battery modules 600 are inserted is mounted to the electric vehicle or the like, and therefore the mounting portion 350 is generally formed on the outer side of the battery case. Further, to stably couple/mount the battery case, the plurality of mounting portions 350 are generally formed. The plurality of mounting portions 350 are provided on a first lateral side of the battery case, and also provided on a lateral side opposite to the first lateral side.

Referring to FIG. 2, the single fastener 300 is formed extending along the lengthwise direction of a lateral side where the plurality of mounting portions 350 are not formed. On the other hand, the plurality of fasteners 300 are formed on a lateral side where the plurality of mounting portions 350 are formed. Referring to FIG. 3, in more detail, the fasteners 300 are formed between the mounting portions 350 on the lateral side where the plurality of mounting portions 350 are formed.

In other words, the fasteners 300 are formed between the mounting portions 350 on the lateral side where the plurality of mounting portions 350 are formed because the fastener 300 cannot be extended due to the mounting portions 350, but the single fastener 300 is formed extending along the lengthwise direction of the lateral side where the plurality of mounting portions 350 are not formed, thereby having effects on not only reducing the number of parts but also shortening the time taken in fastening the housing 100 and the cover 200.

FIG. 1 is a view illustrating a battery case according to an embodiment of the disclosure, FIG. 4 is a view illustrating operations of a fastener 300 in a battery case according to an embodiment of the disclosure, and FIG. 5 is a view illustrating a fastened state of the fastener 300 in a battery case according to an embodiment of the disclosure.

Referring to FIG. 1, the battery case according to the disclosure further includes a seal or sealer 340 provided between the end facing the cover 200 at the edge of the opening of the housing 100 and the end facing the opening of the housing 100 at the edge of the cover 200, in which the sealer 340 is compressed as the cover 200 is fastened to the opening of the housing 100.

In other words, the sealer 340 is additionally provided between the edge end of the opening of the housing 100 and the edge end of the cover 200 which are in contact with each other by the fastener 300, thereby further improving the sealing performance of the inner space of the housing 100 when the cover 200 is fastened to the opening of the housing 100.

Here, the sealer 340 may be provided to be applied, or may be inserted as made of rubber or the like sealing member.

Referring to FIGS. 4 and 5, in more detail, the sealer 340 may be applied or inserted on inner sides at points where the fasteners 300 of the battery case according to the disclosure are formed.

In other words, as shown in FIGS. 4 and 5, a recessed groove into which the sealer 340 is applied or inserted may be formed on the inner side at the connected point between the handle 310 of the fastener 300 and the cover 200 or the housing 100. By applying or inserting the sealer 340 into the recessed groove, a contact point between the cover 200 and the housing 100 sealed by the sealer 340, thereby further improving the sealing performance.

Meanwhile, referring to FIG. 1, the battery case according to the disclosure may further include the electrode plate 400 that is formed to penetrate the cover 200 and has a first side provided in the inner space of the housing 100 and thermally connected to the battery heat generating portion 610, and a second side provided outside the cover 200 and enabling the battery to be charged and discharged.

In general, the battery heat generating portion 610 has a bus bar structure where the lead portions of the battery cell are thermally connected to each other. The electrode plate 400 of the battery case according to the disclosure is thermally connected to the battery heat generating portion 610, thereby enabling the battery modules 600 mounted to the inside of the battery case to be charged and discharged. To this end, the electrode plate 400 needs to be formed both inside and outside the battery case, and thus the electrode plate 400 is formed to penetrate the battery case.

Specifically, the electrode plate 400 has the first side provided in the inner space of the housing 100 and thermally connected to the battery heat generating portion 610, and the second side provided outside the cover 300 and enabling the battery to be charged and discharged. In other words, the electrode plate 400 is preferably formed to penetrate the cover 200.

On the bottom of the inner space of the housing 100, the battery module 600 is mounted and fixed. Further, to prevent the battery from moving due to vibration or shaking that may occur due to various causes while the battery is operating, a separate fixing means for more firmly fixing the position of the battery may be additionally provided as necessary.

Further, as described above, when the direction of gravity is taken into account, the battery modules 600 are inserted into and mounted in the inner space of the housing 100, and then the opening generally opened upwards in the housing 100 is covered with the cover 200. Therefore, the battery module is generally mounted to the electric vehicle or the like with the cover 200 located on an upper side and the housing 100 located on a lower side.

Therefore, the bottom of the housing 100 is close to the lower side of the vehicle body, and the cover 200 is relatively far away from the lower side of the vehicle body. However, various vehicle parts such as wheels and an air conditioner are located in the lower side of the vehicle body.

Therefore, when relationships with the vehicle parts or the fixing means separately provided on the bottom of the inner space of the housing 100 are taken into account, it is advantageous to form the electrode plate 400 in the cover 200 rather than in the housing 100 where the space for installing the electrode plate 400 is limited, in terms of not only the design of the vehicle but also its structure.

Meanwhile, referring to FIG. 1, the battery case according to the disclosure includes a shock absorber 120 on a lower surface of the inner space of the housing 100, and the shock absorber 120 supports the battery modules 600 mounted to the inner space of the housing 100 in an upward direction and absorbs external shocks applied from the lower side of the housing 100.

The shock absorber 120 may be understood as the foregoing fixing means separately provided on the bottom of the inner space of the housing 100. In other words, to prevent the battery from moving due to vibration or shaking that may occur due to various causes while the battery is operating, the separate fixing means for more firmly fixing the position of the battery is provided.

Specifically, according to the disclosure, the shock absorber 120 is provided on the lower surface of the inner space of the housing 100, and absorbs external shocks applied from the lower side of the housing 100 to the battery module 600. Further, the shock absorber 120 supports the battery module 600 upwards, so that the battery heat generating portion 610 can maintain its position corresponding to the electrode plate 400 formed in the cover 200. Therefore, the thermal connection between the battery heat generating portion 610 and the electrode plate 400 is stable, and also the connection of the battery heat generating portion 610 and the electrode plate 400 with the cover 200 is optimized.

For reference, the shock absorber 120 may be provided by applying a gap filler. To press the battery module 600 against a heat transfer compound or minimize damage to the battery cell, the battery modules 600 may be first fixed on the bottom of the inner space of the housing 100 and then the compound may be injected to a gap. However, the method of applying the gap filler is merely an example to help the understanding of the disclosure. Alternatively, various other types of the shock absorber 120 may be used, and the disclosure is not limited to such an example.

FIG. 6 is a view illustrating a heat management system for a battery module according to an embodiment of the disclosure.

Referring to FIG. 6, the heat management system for the battery module according to the disclosure may include a plurality of battery cases; a hub channel 900 connected to the inlet 110 and the outlet 210 formed for the nonconductive refrigerant in each battery case, and allowing the nonconductive refrigerant to flow therein; a plurality of valves 800 provided in the hub channel 900 and controlling the flow rate of the nonconductive refrigerant flowing into each battery case; and the controller 700 individually controlling each valve 800 to adjust the inner temperature of each battery case and the level of the nonconductive refrigerant.

To help the understanding of the disclosure, the operating principle of the battery module heat management system according to the disclosure will be described while describing the elements.

In the battery module heat management system according to the disclosure, the refrigerant circulates through the hub channel 900 connected to the inlet 110 and the outlet 210 formed for the nonconductive refrigerant in each of the battery cases, thereby controlling the temperature of the battery modules 600 inserted into and mounted in the inner space of each battery case to remain constant.

The refrigerant continuously circulates from the time when the battery starts operating, thereby maintaining the battery module 600 at a constant temperature. In this case, to maintain the constant temperature, it is necessary to control the flow rate of the nonconductive refrigerant flowing in each battery case. Therefore, the battery module heat management system according to the disclosure includes the plurality of valves 800 to control the flow rate of the nonconductive refrigerant flowing in each battery case.

When there is an abnormality in the inner temperature of a certain battery case or the level of the nonconductive refrigerant, the controller 700 individually controls each valve 800 to adjust the flow rate of the nonconductive refrigerant flowing into the abnormal battery case. For reference, the controller 700 may be understood as a battery management system (BMS).

In conclusion, the plurality of valves 800 are individually controlled by the controller 700, so that the battery heat generating portion 610 is quickly cooled by concentrating the flow rate of the nonconductive refrigerant flowing into the abnormal battery case, thereby preventing the battery module 600 from overheating.

Meanwhile, the hub channel 900 of the battery module heat management system according to the disclosure includes an inflow channel 910 through which the nonconductive refrigerant flows into the battery case, and a recovery channel 920 through which the nonconductive refrigerant passed through the battery case is recovered. The plurality of battery cases with the battery modules 600 inserted in the inner spaces thereof are arranged adjacent to each other, and the inlets 10 for the nonconductive refrigerant of the battery cases are disposed facing each other. The inflow channels 910 may be disposed between the opposite inlets 110 for the nonconductive refrigerant of the battery cases.

Referring to FIG. 6, the nonconductive refrigerant circulates flowing in a direction A where the inflow channel 910 of the hub channel 900 is formed, passing through the plurality of battery cases, and is then recovered in a direction B where the recovery channel 920 of the hub channel 900 is formed. For reference, it will be understood that the hub channel 900 is connected to a cooling system of a vehicle in the direction B, releases waste heat (absorbed from the battery modules 600) through a chiller, and returns back in the direction A.

Further, the plurality of battery cases are arranged adjacent to each other as shown in FIG. 6, thereby ensuring an effect on the maximum use of the battery modules 600 in the same space. In other words, design may be suitable for the electric vehicle battery industry, to which the disclosure is applied, by utilizing a compact space.

In addition, the inlets 110 formed for the nonconductive refrigerant in the battery cases are arranged facing each other, and the inflow channel 910 is disposed between the opposite inlets 110 formed for the nonconductive refrigerant in the battery cases, so that the nonconductive refrigerant can flow into each battery case through the single inflow channel 910 without separately preparing a plurality of inflow channels 910. Therefore, an advantageous structure is secured in terms of design, and the number of parts and cost are reduced as the single inflow channel 910 is provided.

Further, in the battery module heat management system according to the disclosure, the plurality of valves 800 is provided in the inflow channel 910, and each valve 800 is connected to the opposite inlets 110 for the nonconductive refrigerant, thereby controlling the flow rate of the nonconductive refrigerant flowing into the opposite battery cases.

In other words, as described above, the inflow channel 910 is formed in the inlet 110 formed for the nonconductive refrigerant in each of the plurality of battery cases, and the plurality of valves 800 is provided in the inflow channel 910 so that each valve 800 can be connected to the opposite inlets 110 for the nonconductive refrigerant, thereby controlling the flow rate of the nonconductive refrigerant flowing into the opposite battery case.

Therefore, only one valve 800 rather than two valves 800 is used to control the flow rate of the nonconductive refrigerant flowing into two opposite battery cases, and thus the number of valves 800 needed for operating the battery module heat management system according to the disclosure is reduced in half.

For reference, the valve 800 may be implemented as a multi-way valve, and may for example be implemented as a 3-way value or a 4-way valve as shown in FIG. 6.

As a result, the plurality of valves 800 are arranged in the inlets 110 formed for the nonconductive refrigerant in the battery case, thereby having effects on reducing the number of parts and cost.

FIG. 2 is an exploded perspective view of a battery case according to an embodiment of the disclosure.

Referring to FIG. 2, the battery module heat management system according to the disclosure may further include a sensor 500 to detect the level of the nonconductive refrigerant in each battery case and the temperature of the battery heat generating portion 610, and the controller 700 may individually control the plurality of valves 800 based on detection results of the sensor 500.

As described above, when there is an abnormality in the inner temperature of a certain battery case or the level of the nonconductive refrigerant, the controller 700 individually controls each valve 800 to adjust the flow rate of the nonconductive refrigerant flowing into the abnormal battery case.

In this case, the sensor 500 is separately provided in the battery case. The sensor 500 detects the temperature of the battery heat generating portion 610 to identify whether there is an abnormality in the inner temperature of the battery case. Although there is no abnormality in the internal temperature, the sensor 500 detects the level of the nonconductive refrigerant in the battery case to identify whether the level remains constant.

For example, when the battery heat generating portion 610 excessively overheats and the inner temperature suddenly rises, the sensor 500 detects the inner temperature and transmits a detection result to the controller 700. The controller 700 controls each valve 800 based on the received detection result, thereby quickly cooling the excessively overheated battery heat generating portion 610.

In more detail, when the detection result of the sensor 500 is higher than a reference temperature, the controller 700 of the battery module heat management system according to the disclosure may open the valve 800 to concentrate the flow rate of the nonconductive refrigerant on the corresponding battery case.

Here, the reference temperature may be understood as a dangerous temperature range higher than or close to a usual ignition temperature (180° C.) of the battery cell, and may be stored in a memory of the controller 700 as an average value of preset data values based on many experiments.

In other words, when the received detection result is higher than the ignition temperature or within the dangerous temperature range, the controller 700 controls the valve 800 to concentrate the flow rate of the nonconductive refrigerant on the battery case of which the inner temperature suddenly rises, thereby quickly cooling the battery heat generating portion 610 and preventing the battery module 600 from overheating.

Further, when the detection result of the sensor 500 does not reach a reference level, the controller 700 of the battery module heat management system according to the disclosure may open the valve 800 to concentrate the flow rate of the nonconductive refrigerant on the corresponding battery case.

As described above, when the inner temperature of the battery cell rises above the usual ignition temperature (180° C.), a separator shrinks causing an anode and a cathode of the battery to meet, thereby resulting in a short-circuit.

When the liquid immersion cooling method is used to cool the battery module 600, the battery heat generating portion 610 is maintained in an immersed state, thereby preventing the short-circuit even though the anode and the cathode meet.

Therefore, it is necessary for controlling the internal temperature of the battery case to be within a predetermined temperature condition range, and controlling the level of the nonconductive refrigerant inside the battery case to remain constant.

In other words, although there is no abnormality in the internal temperature, the sensor 500 detects the level of the nonconductive refrigerant in the battery case and transmits the detection result to the controller 700. When the detection result does not reach a reference level, the controller 700 controls each valve 800 to maintain the reference level. For reference, the reference level may be understood as the minimum level at which the battery heat generating portion 610 is maintained in the immersed state.

As a result, the battery heat generating portion 610 is maintained in the immersed state, and therefore a short-circuit is prevented even though the anode and the cathode meet, thereby preventing the battery from igniting to cause fire.

Although specific embodiments of the disclosure have been illustrated and described, it will be obvious to a person having ordinary knowledge in the art that various modifications and changes can be made without departing from the technical scope of the disclosure defined by the appended claims.

1. A battery case comprising:
a housing comprising an inner space and an opening; configured for a battery module to be inserted into and mounted in the inner space through the opening;
a cover fastened to the opening of the housing to close the opening, sealing the inner space of the housing upon closing the opening, and removable from the opening; and
an inlet and an outlet formed in the housing or the cover, allowing a nonconductive refrigerant to flow into or out of the inner space of the housing so that the battery module in the inner space of the housing exchanges heat with the nonconductive refrigerant.

2. The battery case of claim 1, wherein the inlet for the nonconductive refrigerant is formed in the housing, and the outlet for the nonconductive refrigerant is formed in the cover.

3. The battery case of claim 1, further comprising a fastener to fasten the cover to the opening of the housing.

4. The battery case of claim 3, wherein the housing comprises a locking protrusion for fastening of the fastener, and the fastener is provided in the cover and comprises a locking portion formed on a first side thereof and hooked to the locking protrusion, and a handle formed on a second side thereof to fasten or unfasten the locking portion so that the housing and the cover are fastened as the locking portion is hooked to the locking protrusion.

5. The battery case of claim 3, wherein the cover comprises a locking protrusion for fastening of the fastener, and the fastener is provided in the housing and comprises a locking portion formed on a first side thereof and hooked to the locking protrusion, and a handle formed on a second side thereof to fasten or unfasten the locking portion so that the housing and the cover are fastened as the locking portion is hooked to the locking protrusion.

6. The battery case of claim 3, wherein the housing comprises a plurality of mounting portions for fastening the battery case to a vehicle body, the fasteners are formed between the mounting portions on a lateral side where the plurality of mounting portions are formed, and a single fastener is formed extending along a lengthwise direction of a lateral side where the plurality of mounting portions are not formed.

7. The battery case of claim 1, further comprising a sealer provided between an end facing the cover at an edge of the opening of the housing and an end facing the opening of the housing at an edge of the cover, wherein the seal is compressed as the cover is fastened to the opening of the housing.

8. The battery case of claim 1, further comprising an electrode plate formed to penetrate the cover, and comprising a first side provided in the inner space of the housing and thermally connected to a battery heat generating portion, and a second side provided outside the cover and enabling the battery to be charged and discharged.

9. The battery case of claim 1, further comprising a shock absorber provided on a lower surface of the inner space of the housing, supporting the battery modules mounted to the inner space of the housing in an upward direction, and absorbing external shocks applied from a lower side of the housing.

10. A heat management system for a battery module with the battery case of claim 1, comprising:
a plurality of battery cases;
a hub channel connected to the inlet and the outlet formed for the nonconductive refrigerant in each battery case, and allowing the nonconductive refrigerant to flow therein;
a plurality of valves provided in the hub channel and controlling a flow rate of the nonconductive refrigerant flowing into each battery case; and
a controller configured to individually control each valve to adjust an inner temperature of each battery case and a level of the nonconductive refrigerant.

11. The heat management system of claim 10, wherein
the hub channel comprises an inflow channel through which the nonconductive refrigerant flows into the battery case, and a recovery channel through which the nonconductive refrigerant passed through the battery case is recovered,
the plurality of battery cases with the battery modules inserted in the inner spaces thereof are arranged adjacent to each other, and the inlets for the nonconductive refrigerant of the battery cases are disposed facing each other, and the inflow channels are disposed between opposite inlets for the nonconductive refrigerant of the battery cases.

12. The heat management system of claim 11, wherein the plurality of valves is provided in the inflow channel, and each valve is connected to the opposite inlets for the nonconductive refrigerant to control the flow rate of the nonconductive refrigerant flowing into opposite battery cases.

13. The heat management system claim 10, wherein
each battery case further comprises a sensor configured to detect a level of the nonconductive refrigerant and a temperature of a battery heat generating portion, and the controller is configured to individually control the plurality of valves based on detection results of the sensors.

14. The heat management system of claim 13, wherein the controller is configured to open the valve to concentrate the flow rate of the nonconductive refrigerant on a corresponding battery case when the sensor's detection result is higher than or equal to a reference temperature.

15. The heat management system of claim 13, wherein the controller is configured to open the valve to concentrate the flow rate of the nonconductive refrigerant on a corresponding battery case when the sensor's detection result does not reach a reference level.
